(19) United States
(12) Patent Application Publication
(10) Pub. No.: US 2026/0013568 A1
(43) Pub. Date: Jan. 15, 2026

(54) AEROSOL GENERATING DEVICE

(71) Applicant: KT&G CORPORATION, Daejeon (KR)

(72) Inventors: Young Bum KWON, Gyeonggi-do (KR); Dong Sung KIM, Seoul (KR); Yong Hwan KIM, Gyeonggi-do (KR); Hun Il KIM, Seoul (KR)

(73) Assignee: KT&G CORPORATION, Daejeon (KR)

(21) Appl. No.: 18/994,525

(22) PCT Filed: Dec. 29, 2023
(86) PCT No.: PCT/KR2023/022015

§ 371 Date: Jan. 14, 2025

(30) Foreign Application Priority Data
Dec. 30, 2022 (KR) 10-2022-0191047
Mar. 9, 2023 (KR) 10-2023-0031088

(51) Int. Cl. A24F 40/51; A24F 40/20; A24F 40/465; A24F 40/485; A24F 40/53; A24F 40/60; G01L 9/08; H05B 6/10; H05B 6/44

(52) U.S. Cl. CPC A24F 40/51; A24F 40/20; A24F 40/465; A24F 40/485; A24F 40/53; A24F 40/60; G01L 9/08; H05B 6/105; H05B 6/44

(57) ABSTRACT

An aerosol generating device according to an embodiment includes a housing including an accommodation portion into which a cigarette is inserted and an airflow passage fluid-connected to the accommodation portion, a piezoelectric pressure sensor arranged adjacent to a portion of the airflow passage and fluid-connected to the airflow passage through a vent hole, and a processor configured to calculate a pressure variation in the airflow passage by using the piezoelectric pressure sensor. The vent hole extends diagonally with respect to a surface of a piezoelectric element of the piezoelectric pressure sensor.

### TECHNICAL FIELD

The present disclosure relates to an aerosol generating device, and more particularly, to an aerosol generating device capable of detecting a user's puffs by using a piezoelectric pressure sensor.

### BACKGROUND ART

Recently, the demand for a smoking method to replace general cigarettes has increased. For example, there is an increasing demand for a method of generating an aerosol by heating an aerosol generating material in cigarettes, rather than by burning cigarettes. Accordingly, studies on a heating-type cigarette or a heating-type aerosol generating device have been actively conducted.

Commonly, an aerosol generating device includes a pressure sensor to detect a user's inhalation, which is commonly referred to as a puff. However, the sensing accuracy and reliability of a general pressure sensor may degrade because of an aerosol, droplets, and the like that are generated while an aerosol generating device operates.

### DISCLOSURE OF INVENTION

### Technical Problem

The present disclosure provides an aerosol generating device with improved puff sensing accuracy and reliability.

The technical problems of the present disclosure are not limited to the afore-mentioned description, and other technical problems may be clearly understood by one of ordinary skill in the art from the present specification and the attached drawings.

### Solution to Problem

An aerosol generating device according to an embodiment includes a housing including an accommodation portion configured to accommodate a cigarette and an airflow passage fluid-connected to the accommodation portion, a piezoelectric pressure sensor arranged adjacent to a portion of the airflow passage and fluid-connected to the airflow passage through a vent hole, and a processor configured to calculate a pressure variation in the airflow passage by using the piezoelectric pressure sensor. The vent hole extends diagonally with respect to a surface of a piezoelectric element of the piezoelectric pressure sensor.

An aerosol generating device according to an embodiment includes a housing including an accommodation portion configured to accommodate a cigarette, an airflow passage fluid-connected to the accommodation portion, and a chamber arranged apart from the airflow passage, a piezoelectric pressure sensor arranged adjacent to the chamber and fluid-connected to the chamber through a vent hole, and a processor configured to calculate a pressure variation in the chamber by using the piezoelectric pressure sensor. The vent hole extends diagonally with respect to a surface of a piezoelectric element of the piezoelectric pressure sensor.

### Advantageous Effects of Invention

An aerosol generating device according to one or more embodiments uses a piezoelectric sensor for puff sensing to provide robustness and excellent linearity in a range of usage frequencies and amplitudes. Also, because of low sensitivity of the aerosol generating device to an electromagnetic field, the possibility of interference with sensors for detecting changes in inductance and capacitance may be reduced.

Effects of the embodiments are not limited to those stated above, and effects that are not described herein may be clearly understood by one of ordinary skill in the art from the present specification and the attached drawings.

### BRIEF DESCRIPTION OF DRAWINGS

FIG. 1 is a perspective view of an aerosol generating device according to an embodiment.

FIG. 2 is a schematic diagram of components of an aerosol generating device, according to an embodiment.

FIG. 3 schematically illustrates a coil of an aerosol generating device using an induction heating method, according to an embodiment.

FIG. 4A is an enlarged cross-sectional view of some components of an aerosol generating device, according to an embodiment.

FIG. 4B is a diagram for explaining a movement of air according to a puff action of a user in the aerosol generating device of FIG. 4A.

FIG. 5 is a block diagram of some components of an aerosol generating device, according to an embodiment.

FIG. 6 is a diagram for explaining a state in which a visual notification is provided through a display in an aerosol generating device, according to an embodiment.

FIG. 7 schematically illustrates components of an aerosol generating device according to another embodiment.

FIGS. 8A and 8B are diagrams for explaining a spiral coil of an aerosol generating device, according to another embodiment.

FIG. 9A is an enlarged cross-sectional view of some components of an aerosol generating device, according to another embodiment.

FIG. 9B is a diagram for explaining movement of air according to a puff action of a user in the aerosol generating device of FIG. 9A.

FIG. 10A is an enlarged diagram of some components of an aerosol generating device, according to another embodiment.

FIG. 10B is a diagram for explaining a process by which air moves in the aerosol generating device of FIG. 10A according to a puff action of a user.

FIG. 11A is an enlarged cross-sectional view of some components of an aerosol generating device, according to another embodiment.

FIG. 11B is a diagram for explaining a movement of air according to a puff action of a user in the aerosol generating device of FIG. 11A.

FIG. 12 is a block diagram of an aerosol generating device according to another embodiment.

### BEST MODE FOR CARRYING OUT THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, the present disclosure is described in detail with reference to the attached drawings.

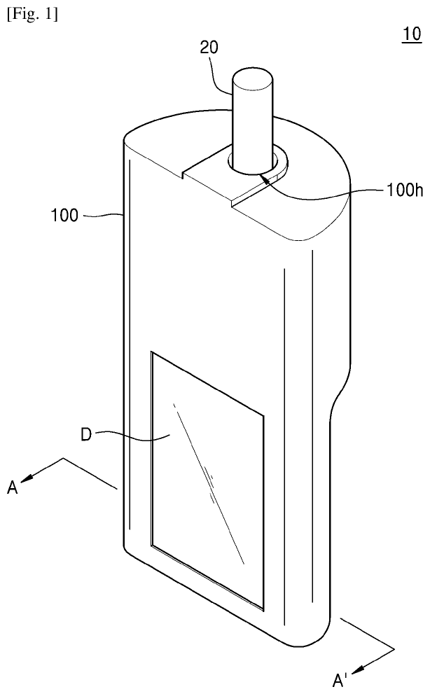

FIG. 1 is a perspective view of an aerosol generating device according to an embodiment.

Referring to FIG. 1, an aerosol generating device 10 according to an embodiment may include a housing 100 into which a cigarette 20 may be inserted.

The housing 200 may form a general exterior of the aerosol generating device 10 and include an inner space (or ‘an arrangement space’) in which components of the aerosol generating device 10 may be arranged. FIG. 1 shows that a cross-sectional shape of the housing 100 is a semicircle, but the shape of the housing 100 is not limited thereto. According to another embodiment, the shape of the housing 100 may generally be a cylinder or a polyprism (e.g., a triangular prism or a rectangular prism).

Components for generating an aerosol by heating the cigarette 20 inserted into the housing 100 and components for detecting a user's puff may be arranged in the inner space of the housing 100. The components are described below in detail.

According to an embodiment, the housing 100 may include an opening 100h through which the cigarette 20 may be inserted into the housing 100. At least a portion of the cigarette 20 may be inserted into or accommodated in an accommodation portion 110 through the opening 100h.

As the cigarette 20 inserted into or accommodated in the accommodation portion 110 is heated inside the housing 100, an aerosol may be generated. The generated aerosol may be discharged to the outside of the aerosol generating device 10 through the inserted cigarette 20 and/or a space between the cigarette 20 and the opening 100h, and the user may inhale the discharged aerosol.

The aerosol generating device 10 according to an embodiment may further include a display D on which visual information is displayed.

According to an embodiment, the display D may be arranged such that at least a portion of the display D may be exposed on an outer side of the housing 100, and the aerosol generating device 10 may provide various pieces of visual information to the user through the display D.

For example, the aerosol generating device 10 may provide, through the display D, information regarding whether a puff action is performed by the user or information regarding the remaining puffs for the inserted cigarette 20, but the information provided through the display D is not limited thereto.

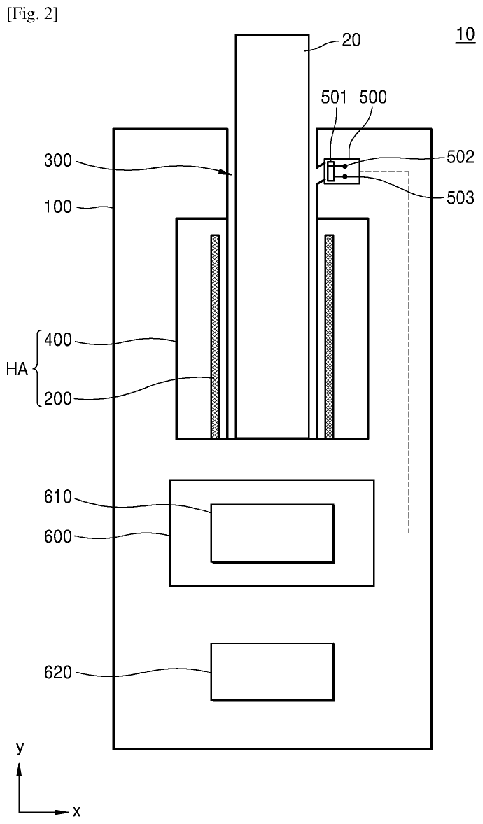

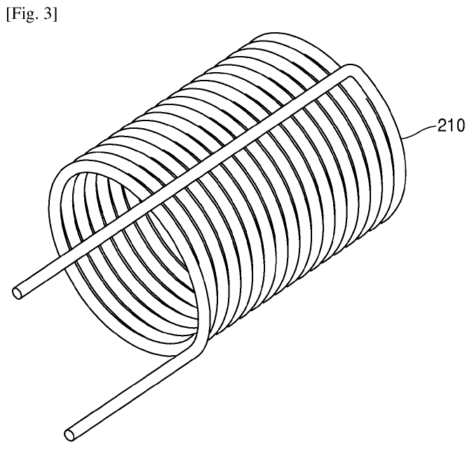

FIG. 2 is a schematic diagram of components of an aerosol generating device, according to an embodiment. FIG. 3 schematically illustrates a coil of an aerosol generating device in an induction heating method, according to an embodiment. In this case, FIG. 2 is a cross-sectional view of the aerosol generating device of FIG. 1, taken along line A-A′ and illustrates some components arranged inside the housing.

Referring to FIG. 2, the aerosol generating device 10 according to an embodiment may include the housing 100, a heater 200, an airflow passage 300, an insulation structure 400, and a piezoelectric pressure sensor 500. In this case, the heater 200 and the insulation structure 400 may be included in a heating assembly HA. Components of the aerosol generating device 10 are not limited thereto, and according to one or more embodiments, other components (e.g., a vaporizer) may be added thereto or at least one component may be omitted.

The housing 100 may include an inner space where the components of the aerosol generating device 10 may be arranged, and the housing 100 may form an overall exterior of the aerosol generating device 10. The drawing only shows that a cross-sectional shape of the housing 100 is a semicircle, but the shape of the housing 100 is not limited thereto. According to an embodiment (not shown), the shape of the housing 100 may generally be a cylinder or a polyprism (e.g., a triangular prism or a rectangular prism).

According to an embodiment, the housing 100 may include an opening 100h through which the cigarette 20 may be inserted into the housing 100. At least a portion of the cigarette 20 may be inserted into or accommodated in the accommodation portion 110 through the opening 100h.

The heater 200 may generate an aerosol by heating the cigarette 20 inserted into or accommodated in the accommodation portion 110 through the opening 100h. The heater 200 may heat the cigarette 20 by generating heat according to, for example, a power supply. In this case, vaporized particles generated by heating the cigarette 20 may be mixed with air flowing into the housing 100 through the opening 100h, and thus, the aerosol may be generated.

In an embodiment, the heater 200 may include an induction heater. For example, the heater 200 may include a coil (or ‘an electrically conductive coil’) for generating an alternating magnetic field according to power supply, and a susceptor for generating heat by the alternating magnetic field generated by the coil. The susceptor may be arranged to surround at least a portion of an outer circumferential surface of the cigarette 20 inserted into the housing 100 and thus heat the inserted cigarette 20.

Referring to FIG. 3, for example, the coil 210 included in the induction heater may be implemented as a solenoid formed by a tightly and uniformly wound wire in a long cylindrical shape. In an inner space of the solenoid, an accommodation space into which the cigarette 20 is inserted may be formed.

According to another embodiment, the heater 200 may include an electro-resistive heater. For example, the heater 200 may include a film heater arranged to surround at least a portion of the outer circumferential surface of the cigarette 20 inserted into the housing 100. The film heater may include an electrically conductive track, and as currents flow through the electrically conductive track, the film heater may generate heat to heat the cigarette 20 inserted into the housing 100.

According to another embodiment, the heater 200 may include at least one of a needle-type heater, a rod-type heater, and a tube-type heater which may heat the inside of the cigarette 20 inserted into the housing 100. The heater may be inserted into, for example, at least a portion of the cigarette 20 and heat the inside of the cigarette 20.

The heater 200 is not limited to the above embodiments, and the embodiments of the heater 200 may be modified as long as the heater 200 may heat the cigarette 20 to a designated temperature. In the present specification, the expression “designated temperature” may indicate a temperature at which an aerosol generating material included in the cigarette 20 is heated and an aerosol is generated. The designated temperature may be a temperature that is set in advance in the aerosol generating device 10, but the temperature may be changed according to a type of aerosol generating device 10 and/or the manipulation of the user.

The airflow passage 300 may be located in the inner space of the housing 100 and connect or fluid-connect the heater 200 to the outside of the housing 100 or the outside of the aerosol generating device 10. According to an embodiment, the airflow passage 300 may extend in a lengthwise direction of the housing 100, an end of the airflow passage 300 may be connected to the heater 200, and the other end thereof may be connected to the opening 100h.

At least part of the aerosol generated by the heater 200 may pass through the cigarette 20 inserted into the housing 100 or move along the airflow passage 300 and may be discharged to the outside of the housing 100 or the aerosol generating device 10 through the opening 100h. Also, air outside the aerosol generating device 10 (hereinafter, referred to as ‘external air’) may flow into the housing 100 through the opening 100h and then move along the airflow passage 300 in a direction towards the heater 200.

The insulation structure 400 may be arranged to surround the outer circumferential surface of the heater 200 to prevent the heat generated by the heater 200 from being externally discharged. In an embodiment, the insulation structure 400 may include a vacuum insulating layer arranged to surround the heater 200 to vacuum-insulate the heater 200, but one or more embodiments are not limited thereto.

In an embodiment, the insulation structure 400 may prevent the heat generated by the heater 200 from being externally discharged and thus maintain the temperature of the heater 200 to a high temperature, thereby reducing the amount of power consumed to operate the heater 200.

In another embodiment, the insulation structure 400 may prevent the heat generated by the heater 200 from being externally discharged, thereby reducing the amount of heat transferred from the heater 200 to the housing 100. Because the heat of the aerosol generating device 10 that the user may feel when grabbing the aerosol generating device 10 may be reduced through the insulation structure 400 in the aerosol generating device 10, the user convenience of the aerosol generating device 10 may be improved.

In another embodiment, the insulation structure 400 may seal the heater 200 and thus prevent droplets from being discharged to the outside of the insulation structure 400, wherein the droplets may be generated while the aerosol generating device 10 operates.

Droplets may be generated by condensation of some aerosols during an aerosol generation process of the heater 200, and the generated droplets may cause malfunction or damage to the components of the aerosol generating device 10. For example, when the droplets generated in the aerosol generation process are introduced to a printed circuit board 600, the printed circuit board 600 may malfunction or be damaged.

The aerosol generating device 10 according to an embodiment includes the insulation structure 400, sealing the heater 200, to prevent the droplets generated in the aerosol generation process of the heater 200 from being externally discharged, and thus, the malfunction or damage to the components of the aerosol generating device 10 by the droplets may be prevented.

The piezoelectric pressure sensor 500 may be arranged adjacent to the airflow passage 300 and connected thereto, thus detecting a pressure variation according to the puff action of the user. That is, the piezoelectric pressure sensor 500 may be fluid-connected to the airflow passage 300 and thus detect a pressure variation in the airflow passage 300.

The piezoelectric pressure sensor 500 may measure pressure or mechanical stress through a piezoelectric effect. In this case, pressure applied to the piezoelectric pressure sensor 500 may be converted into an electrical charge flow. Such a characteristic may be applied to measure the pressure or pressure variation.

The piezoelectric pressure sensor 500 according to an embodiment may be in the form of a disc. The piezoelectric pressure sensor 500 may include a piezoelectric element 501 and first and second electrodes 502 and 503. The piezoelectric element 501 includes a homogenous layer that includes a material sensitive to pressure. For example, the piezoelectric element 501 may include a piezoelectric material, such as lead zirconate titanate (PZT)-ceramic or quartz. The piezoelectric pressure sensor 500 may include a piezoelectric element 501 that is a single body, and the first and second electrodes 502 and 503 may be respectively arranged on one surface and the other surface of the piezoelectric element 501. However, the shape of the piezoelectric pressure sensor 500 is not limited thereto, and the piezoelectric pressure sensor 500 may be variously designed in accordance with the structure of the aerosol generating device 10. For example, the piezoelectric pressure sensor 500 may be in the form of a film.

When puffs are sensed by the piezoelectric pressure sensor 500, the great linearity may be provided in a range of usage frequencies and amplitudes. Also, because of low sensitivity to an electromagnetic field, the piezoelectric pressure sensor 500 may have low interference with the heating-type heater 200 and sensors (not shown) for detecting changes in inductance and capacitance. To this end, by securing the measurement reliability, the piezoelectric pressure sensor 500 may accurately detect the pressure variation in the airflow passage 300 according to the puff action of the user.

The aerosol generating device 10 according to an embodiment may further include a processor 610 and a battery 620.

The processor 610 may control general operations of the aerosol generating device 10. For example, the processor 610 may be electrically or operatively connected to the heater 200 and control the operation of the heater 200. Also, the processor 610 may be electrically or operatively connected to the piezoelectric pressure sensor 500 and detect the puff action of the user based on a result of the detection by the piezoelectric pressure sensor 500.

In the present specification, the expression “operatively connected” may indicate that components exchange signals through wireless communication or connected to each other to exchange optical signals and/or magnetic signals, and such an expression may carry the same meaning below.

According to an embodiment, the processor 610 may be arranged or mounted on the printed circuit board 600 located in the inner space of the housing 100, but the arrangement of the processor 610 is not limited thereto.

The battery 620 may supply power used to operate the aerosol generating device 10. For example, the battery 620 may supply power to the heater 200 to heat the same. Also, the battery 620 may supply the power required to operate the processor 610 or the piezoelectric pressure sensor 500.

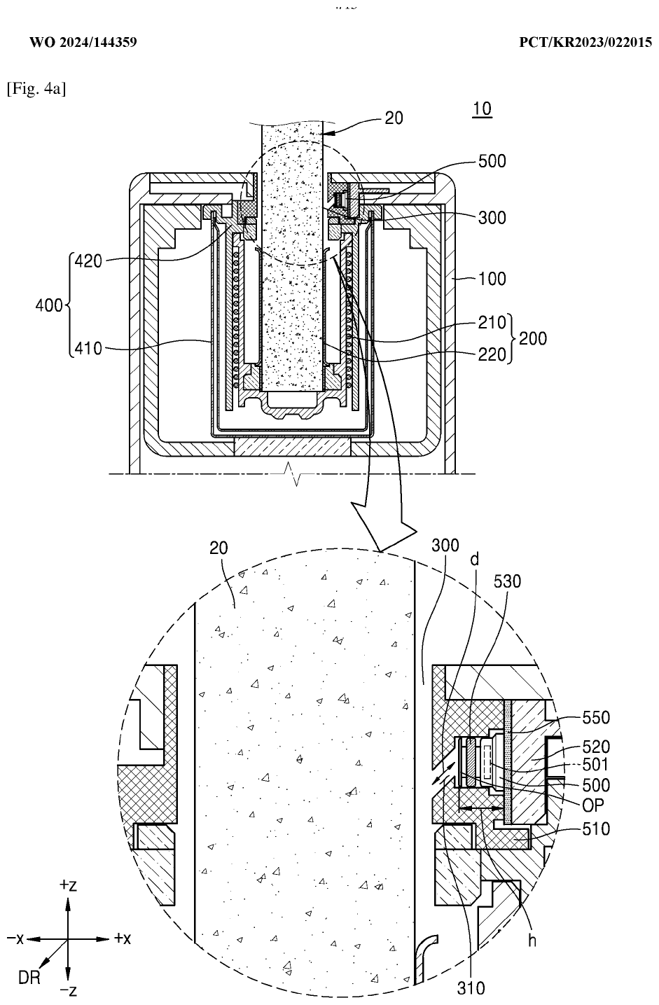

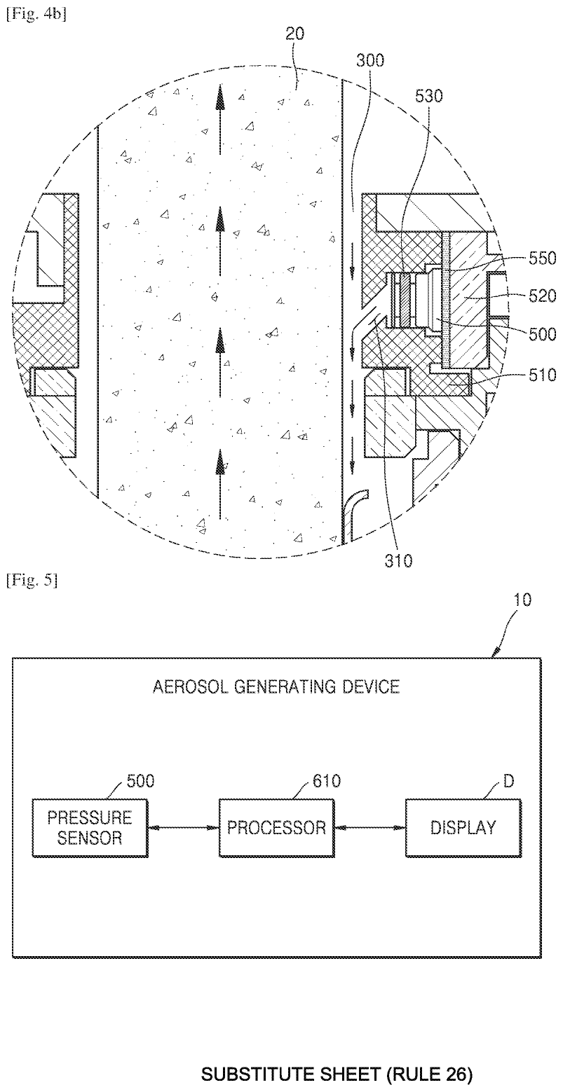

FIG. 4A is an enlarged cross-sectional view of some components of an aerosol generating device, according to an embodiment, and FIG. 4B is a diagram for explaining movement of air according to a puff action of a user in the aerosol generating device of FIG. 4A.

Referring to FIGS. 4A and 4B, the aerosol generating device 10 according to an embodiment may include the housing 100, the heater 200, the airflow passage 300, a vent hole 310, the insulation structure 400, the piezoelectric pressure sensor 500, and a processor (e.g., the processor 610 of FIG. 2). The aerosol generating device 10 of FIGS. 4A and 4B may be an embodiment of the aerosol generating device 10 of FIG. 2.

The heater 200 may be located inside the housing 100 and heat the cigarette 20 inserted into the housing 100, thereby generating an aerosol.

According to an embodiment, the heater 200 may include a coil 210 and a susceptor 220 as shown in FIG. 4A and heat the cigarette 20 inserted into the housing 100 in the induction heating method.

The coil 210 may be arranged to surround an outer circumferential surface of the susceptor 220 and generate an alternating magnetic field according to power supplied from a battery (e.g., the battery 620 of FIG. 1).

The susceptor 220 may be arranged to surround at least a portion of an outer circumferential surface of the cigarette 20 inserted into the housing 100 and thus heat the cigarette 20 inserted into the housing 100. The susceptor 220 may generate heat by using, for example, the alternating magnetic field generated by the coil 210, and as a result, the cigarette 20 may be heated.

The insulation structure 400 may be arranged to surround the outer circumferential surface of the heater 200 and seal the heater 200, thus preventing the droplets, which are generated in the aerosol generation process, from being discharged to the outside. Also, the insulation structure 400 may seal the heater 200 and prevent the heat generated by the heater 200 from being externally discharged, such that an ambient temperature of the heater 200 may be maintained at a high temperature.

According to an embodiment, the insulation structure 400 may include a first structure 410 arranged to surround a portion (e.g., a lower surface and/or a side surface) of the outer circumferential surface of the heater 200 and a second structure 420 located on an upper portion of the first structure 410 and covering another region (e.g., an upper surface) of the outer circumferential surface of the heater 200.

The heater 200 may be located in an inner space formed by the first structure 410 and the second structure 420, and the first structure 410 and the second structure 420 may seal the heater 200 described above. For example, the second structure 420 may be coupled to at least a portion of the upper portion of the first structure 410, but one or more embodiments are not limited thereto. As another example (not shown), the first structure 410 and the second structure 420 may be integrally formed as a single body.

The airflow passage 300 may be arranged to connect the inside of the housing 100 to the outside of the housing 100 or the aerosol generating device 10 and may function as a flow path through which air or an aerosol moves in and out of the aerosol generating device 10.

For example, the aerosol generated inside the aerosol generating device 10 may pass through the cigarette 20 inserted into the housing 100 or move along the airflow passage 300, thus being discharged to the outside of the aerosol generating device 10 or the housing 100. As another example, air outside the aerosol generating device 10 (hereinafter, referred to as ‘external air’) may flow into the inner space of the housing 100 through the airflow passage 300.

The piezoelectric pressure sensor 500 may be arranged adjacent to the airflow passage 300 and connected to the airflow passage 300 through the vent hole 310, thus detecting a pressure variation in the airflow passage 300.

The vent hole 310 may be formed in the sensor bracket 510. A cross-sectional area of the vent hole 310 may be proportional to a surface size of the piezoelectric element 501. For example, the piezoelectric element 501 may be exposed through an opening OP of the piezoelectric pressure sensor 500. A cross-section of the opening OP may have a circular shape. A diameter of the opening OP may be 1.8 mm. In this case, the cross-section of the vent hole 310 may also have a circular shape, and the diameter of the vent hole 310 may also be 1.8 mm. As described, in the aerosol generating device 10 according to an embodiment, the cross-sectional area of the vent hole 310 is formed as great as possible in proportion to the surface size of the piezoelectric element 501 to secure the measurement accuracy, and thus, the pressure variation in the airflow passage 300 according to the puff action of the user may be accurately detected.

A minimum distance d from an end to the other end of the vent hole 310 according to an embodiment may be smaller than a height h of the piezoelectric pressure sensor 500. As described, in the aerosol generating device 10 according to an embodiment, the minimum distance d of the vent hole 310 is formed as small as possible to be close to the airflow passage 300 to secure the measurement accuracy, and thus, the pressure variation in the airflow passage 300 according to the puff action of the user may be accurately detected.

Also, the vent hole 310 according to an embodiment may be diagonally formed with respect to the surface of the piezoelectric element 501 of the piezoelectric pressure sensor 500. For example, the lengthwise direction of the vent hole 310 may be a diagonal direction DR between a-x direction and a-z direction, which forms an acute angle with the upper surface of the piezoelectric element 501. In other words, the lengthwise direction of the vent hole 310 may not be perpendicular to a plane parallel to the upper surface of the piezoelectric element 501. As such, the liquid flowing from the outside or the droplets generated in the aerosol generation process may be prevented from being introduced into the vent hole 310.

The piezoelectric pressure sensor 500 may generate an electrical signal corresponding to the pressure variation in the airflow passage 300, and the electrical signal generated by the piezoelectric pressure sensor 500 may be transmitted to the processor (e.g., the processor 610 of FIG. 2) that is electrically or operatively connected to the piezoelectric pressure sensor 500.

According to an embodiment, the piezoelectric pressure sensor 500 may be arranged on a sensor printed circuit board 550 and may be electrically connected to the processor arranged on a printed circuit board through an electrical connection member (e.g., a flexible printed circuit board) connecting the sensor printed circuit board 550 to the printed circuit board (e.g., the printed circuit board 600 of FIG. 2), but one or more embodiments are not limited thereto.

As connected to the airflow passage 300 through the vent hole 310, the piezoelectric pressure sensor 500 may detect the pressure variation in the airflow passage 300. For example, the piezoelectric pressure sensor 500 may detect the pressure of the vent hole 310 that is connected to or fluid-connected to the airflow passage 300 and thus may sense or detect the pressure variation in the airflow passage 300.

The processor may be electrically or operatively connected to the piezoelectric pressure sensor 500 and detect the puff action of the user based on the pressure variation in the airflow passage 300 that is sensed or detected by the piezoelectric pressure sensor 500.

According to an embodiment, the processor may detect the puff action of the user based on a pressure decrement of the airflow passage 300 that is sensed or detected by the piezoelectric pressure sensor 500.

As illustrated in FIG. 4B, because of the puff action of the user, at least part of the air in the airflow passage 300 and/or the vent hole 310 may pass through the cigarette 20 and be discharged to the outside of the housing 100.

Because of the puff action of the user, a pressure difference may be generated between the outside of the housing 100 and the inside thereof, and thus, the air in the airflow passage 300 and/or the vent hole 310 may be discharged to the outside of the housing 100, resulting in the pressure drop in the airflow passage 300. Accordingly, the processor may detect the puff action of the user based on the pressure decrement of the airflow passage 300 that is sensed by the piezoelectric pressure sensor 500. The processor may, for example, compare a preset value and the pressure decrement of the airflow passage 300 that is sensed or detected by the piezoelectric pressure sensor 500, and when the pressure decrement of the airflow passage 300 is at least the preset value, the processor may determine that the user has performed the puff action. In this case, the preset value may vary according to the type of the aerosol generating device 10 or the user's setting. For example, a designated value P may be about 60 Pa to about 80 Pa, but is not limited thereto.

The aerosol generating device 10 according to an embodiment may further include the sensor bracket 510, a sensor cover 520, and/or an O-ring 530. However, according to another embodiment, at least one of the above-described components may be omitted.

The sensor bracket 510 may be arranged to surround at least a portion of the piezo-electric pressure sensor 500 and prevent the heat generated by the heater 200 from being transferred to the piezoelectric pressure sensor 500 while supporting or fixing the same. According to an embodiment, the sensor bracket 510 may include the vent hole 310 connecting the airflow passage 300 to the piezoelectric pressure sensor 500.

The sensor cover 520 may be arranged to cover at least a portion of the piezoelectric pressure sensor 500 and support the piezoelectric pressure sensor 500. Also, the sensor cover 520 may include a thermally conductive material and dissipate the heat transferred to the piezoelectric pressure sensor 500. For example, at least part of the heat generated by the heater 200 may be transferred to the piezoelectric pressure sensor 500 through convection and/or radiation, and the sensor cover 520 may transfer the heat transferred to the piezoelectric pressure sensor 500 to the outside of the piezo-electric pressure sensor 500 (e.g., the housing 100).

According to an embodiment, the sensor cover 520 may be located opposite to the sensor bracket 510 with respect to the piezoelectric pressure sensor 500 and support another portion of the piezoelectric pressure sensor 500, but the arrangement of the sensor cover 520 is not limited to the above embodiment.

The O-ring 530 may be arranged between the sensor bracket 510 and the piezo-electric pressure sensor 500 and thus prevent the piezoelectric pressure sensor 500 from moving and the air, which flows into the piezoelectric pressure sensor 500 through the airflow passage 300, from leaking. For example, the O-ring 530 may include an elastic material (e.g., rubber) to protect the piezoelectric pressure sensor 500 and prevent the air flowing into the piezoelectric pressure sensor 500 from leaking to the outside of the piezoelectric pressure sensor 500.

That is, in the aerosol generating device 10 according to an embodiment, the malfunction or failure of the piezoelectric pressure sensor 500 may be prevented by insulating or dissipating the piezoelectric pressure sensor 500 by using the sensor bracket 510 and/or the sensor cover 520. As a result, the aerosol generating device 10 may have improved measurement accuracy of the piezoelectric pressure sensor 500 and thus may accurately detect the puff action of the user.

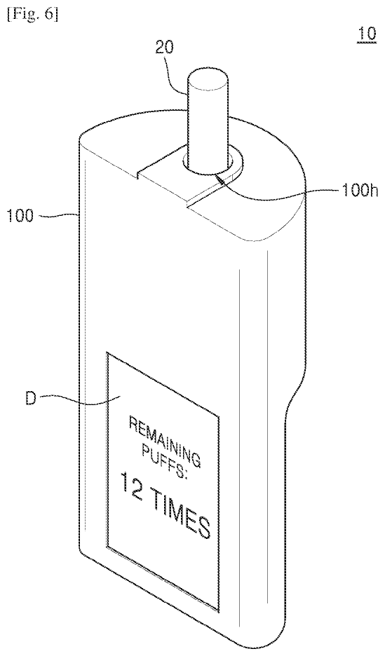

FIG. 5 is a block diagram of some components of an aerosol generating device, according to an embodiment. FIG. 6 is a diagram for explaining a state in which a visual notification is provided through a display in an aerosol generating device, according to an embodiment.

Referring to FIG. 5, the aerosol generating device 10 according to an embodiment may include the piezoelectric pressure sensor 500, the processor 610, and the display D.

The processor 610 may be electrically connected to the piezoelectric pressure sensor 500 and detect the puff action of the user based on the pressure variation in the airflow passage 300 (the airflow passage 300 of FIG. 4A) that is sensed by the piezoelectric pressure sensor 500.

For example, during the puff action of the user, a pressure difference is generated between the inside and outside of the aerosol generating device 10, and at least part of the air inside the aerosol generating device 10 may be discharged to the outside; thus, a pressure drop may occur in the airflow passage.

Accordingly, the processor 610 may sense the puff action of the user based on the pressure decrement of the airflow passage that is sensed by the piezoelectric pressure sensor 500. For example, when the pressure decrement of the airflow passage is at least a pressure value, the processor 610 may determine that the puff action of the user is performed or generated.

Based on the determination that the puff action is performed, the processor 610 may output a notification (or a ‘user notification’) indicating that the puff action of the user has occurred.

The notification may include, but is not limited thereto, at least one of a visual notification notifying the occurrence of the user's puff action based on visual information, an audible notification notifying the occurrence of the user's puff action based on audible information (e.g., sound), and a tactile notification notifying the occurrence of the user's puff action based on tactile information (e.g., vibration).

For example, by displaying, through the display D and/or an LED (not shown), a notification indicating that the puff action of the user has occurred, the processor 610 may output the notification that the puff action of the user has occurred.

As another example, the processor 610 may produce sound through a speaker (not shown) and thus output a notification indicating that the puff action of the user has occurred. As another example, the processor 610 may produce vibration through a motor (not shown) and/or an actuator (not shown) and thus output a notification indicating that the puff action of the user has occurred.

Also, the processor 610 may calculate or count the number of remaining puffs (or ‘the number of puffs left’) of the cigarette 20 inserted into the aerosol generating device 10 based on the number of user's puffs and may output a notification corresponding to the number of remaining puffs.

According to an embodiment, when it is determined that the puff action of the user is performed, the processor 610 may count the puffs of the user and calculate the remaining puffs for the cigarette inserted into the aerosol generating device 10 based on a difference between the preset total number of puffs and the number of puffs counted.

For example, when the total number of puffs for the cigarette is 14 and the number of user's puffs counted is 4, the processor 610 may calculate that the remaining puffs for the inserted cigarette are 10.

The processor 610 may provide information regarding the remaining puffs to the user through, for example, at least one of a visual notification, an audible notification, and a tactile notification, but one or more embodiments are not limited thereto.

According to an embodiment, as illustrated in FIG. 6, the processor 610 may be electrically or operatively connected to the display D arranged in at least a portion of the outer circumferential surface of the housing 100 and thus may output a visual notification corresponding to the number of remaining puffs through the display D.

For example, by displaying the number of remaining puffs on the display D, the processor 610 may notify the user of information regarding the number of remaining puffs for the cigarette 20 inserted into the housing 100. However, the visual information displayed on the display D is not limited to the embodiment of FIG. 6, and visual information displayed on the display D may be modified as long as the information regarding the number of remaining puffs may be provided to the user.

According to another embodiment, the processor 610 may notify the user of information regarding the number of remaining puffs through the sense of hearing and/or touch. For example, the processor 610 may provide the user with the information regarding the number of remaining puffs through an audible notification generating sound corresponding to the number of remaining puffs or a tactile notification generating vibration corresponding to the number of remaining puffs.

According to another embodiment, the processor 610 may notify the user of the information regarding the number of remaining puffs through at least two of a visual notification, an audible notification, and a tactile notification. For example, the processor 610 may simultaneously provide a visual notification and an audible notification or provide a visual notification, an audible notification, and a tactile notification.

Hereinafter, other embodiments are described. In the embodiments below, the components that are the same as those in the above embodiment are not described or briefly described, and differences will be mainly described.

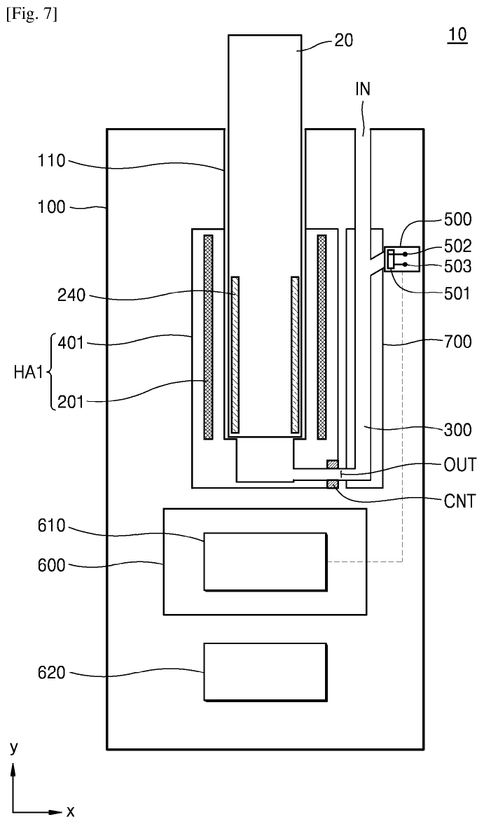

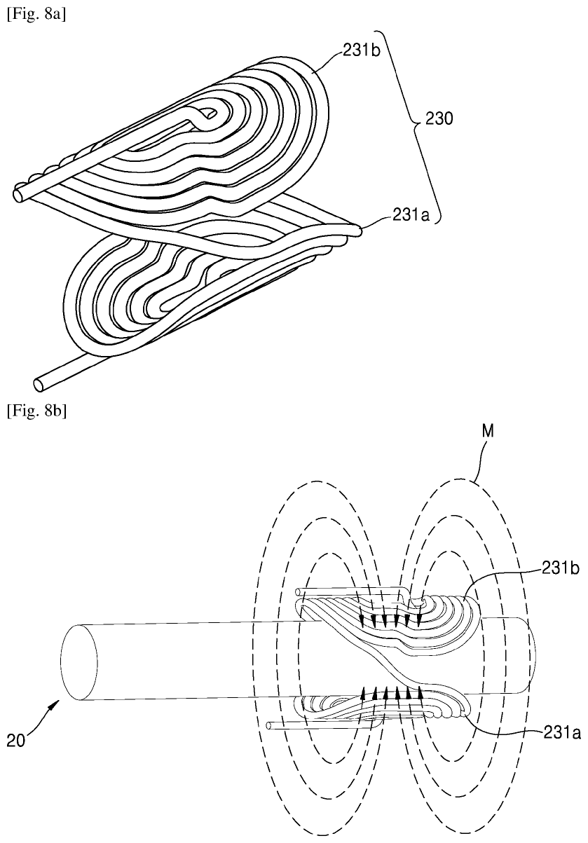

FIG. 7 schematically illustrates components of an aerosol generating device, according to another embodiment. FIGS. 8A and 8B are diagrams for explaining a spiral coil of an aerosol generating device, according to another embodiment.

Referring to FIGS. 7 to 8B, the aerosol generating device 10 of FIG. 7 includes a spiral coil 230, whereas the aerosol generating device 10 of FIG. 2 includes the solenoid coil 210. Also, the aerosol generating device 10 of FIG. 7 is different from the aerosol generating device 10 of FIG. 2 in that an airflow passage 300 of the aerosol generating device 10 of FIG. 7 is apart from a heating assembly HA1 and separately formed in an airflow assembly 700, whereas the aerosol generating device 10 of FIG. 2 includes the airflow passage 300 in the heating assembly HA.

Referring to FIG. 7, the aerosol generating device 10 according to an embodiment may include the housing 100, the heating assembly HA1, the piezoelectric pressure sensor 500, and the airflow assembly 700. Components of the aerosol generating device 10 are not limited thereto, and according to one or more embodiments, other components may be added thereto or at least one component may be omitted.

According to an embodiment, the housing 100 may include an opening (100h of FIG. 1) through which the cigarette 20 may be inserted into the housing 100. At least a portion of the cigarette 20 may be inserted into or accommodated in an accommodation portion 110 through the opening 100h.

The heating assembly HA1 may include a heater 201 and an insulation structure 401.

The heater 201 may generate an aerosol by heating the cigarette 20 inserted into or accommodated in the accommodation portion 110 through the opening 100h. The heater 201 may heat the cigarette 20 by generating heat according to, for example, a power supply. In this case, vaporized particles generated by heating the cigarette 20 are mixed with the air flowing into the housing 100 through the airflow assembly 700 (or an air inlet IN), and thus, the aerosol may be generated.

According to an embodiment, the heater 201 may include an induction heater. For example, the heater 201 may include a coil (or ‘electrically conductive coil’) configured to generate an alternating magnetic field as power is supplied. The cigarette 20 may include therein a susceptor 240. The exterior of the cigarette 20 according to an embodiment may be surrounded by a packaging material (a wrapper). Also, the susceptor 240 may be arranged in some or all portions between the packaging material (the wrapper) and an aerosol generating portion and/or a tobacco charging portion.

FIG. 8A schematically illustrates spiral coils 231a and 231b of the aerosol generating device 10, according to an embodiment, and FIG. 8B is a diagram for explaining a direction of magnetic field lines M generated by the spiral coils 231a and 231b of the aerosol generating device 10, according to an embodiment.

Referring to FIGS. 8A and 8B, the spiral coils 231a and 231b may each have a planar shape that is curved along a circumferential direction of the accommodation portion 110. The center around which the spiral coils 231a and 231b are wound may be located at a point of an outer surface of the accommodation portion 110. That is, the horizontal cross-section of each of the spiral coils 231a and 231b (i.e., a cross section when cut in an x direction crossing the lengthwise direction (i.e., a y direction) of the accommodation portion 110) may have a circular arc shape. A central axis around which the spiral coils 231a and 231b are wound may be a direction crossing the lengthwise direction (i.e., the y direction) of the accommodation portion 110.

The spiral coils 231a and 231b may form a magnetic field in which the magnetic field lines M passes through the central area of the spiral coils 231a and 231b. That is, the magnetic field lines M may pass through the cigarette 20 inserted into the accommodation portion 110 in a direction crossing a lengthwise direction of the cigarette 20.

Because the direction of the magnetic field lines M cross the lengthwise direction of the cigarette 20, the density of the magnetic field lines M passing through the susceptor (240 of FIG. 7) included in the cigarette 20 may increase, and accordingly, the heating efficiency of the susceptor (240 of FIG. 7) may be improved. In particular, when the susceptor (240 of FIG. 7) included in the cigarette 20 has a sheet shape surrounding the cigarette 20, because the magnetic field lines M pass through a wide area, the susceptor (240 of FIG. 7) may be heated at a sufficient temperature.

The spiral coils 231a and 231b may each be provided in plural. As illustrated in FIGS. 8A and 8B, two spiral coils 231a and 231b including a first spiral coil 231a and a second spiral coil 231b may be arranged. The first spiral coil 231a and the second spiral coil 231b may have the same size and shape and may be symmetrically arranged with respect to the central axis of the accommodation portion 110.

The first spiral coil 231a and the second spiral coil 231b may each have a circular shape when viewed along the central axis of the spiral coils 231a and 231b. However, one or more embodiments are not limited thereto, and the number, sizes, and shapes of spiral coils 231a and 231b may change according to necessity. For example, when viewed along the central axis of the spiral coil, the spiral coil may have a rectangular shape, and four spiral coils may be arranged at regular intervals.

The spiral coils 231a and 231b may be provided in plural such that they are electrically connected to each other. When multiple spiral coils 231a and 231b are arranged, it is required to precisely control the direction of the alternating current applied to each of the spiral coils 231 and 231b to prevent the intensities of the magnetic fields generated by the spiral coils 231a and 231b from being offset due to crossing of directions of the magnetic fields. However, when the spiral coils 231a and 231b are electrically connected to each other, the alternating currents flow in the spiral coils 231a and 231b in the same direction, and thus, separate control over the directions of the alternating currents is not required.

Referring back to FIG. 7, the airflow assembly 700 may be spaced apart from the heating assembly HA1 and separately formed. The airflow assembly 700 may include the air inlet IN formed in an end of the airflow assembly 700 and an air outlet OUT formed in the other end of the airflow assembly 700 and connected to the air inlet IN by the airflow passage 300. The air outlet OUT may be connected to a connection passage CNT formed in a portion of the accommodation portion 110.

The airflow passage 300 may be arranged in the inner space of the airflow assembly 700 and connect or fluid-connect the heater 201 to the outside of the housing 100 or the aerosol generating device 10.

At least part of the aerosol generated by the heater 201 may pass through the cigarette 20 inserted into the housing 100 and may be discharged to the outside of the housing 100 or the aerosol generating device 10 through the opening (100h of FIG. 1).

The insulation structure 401 may be arranged to surround the outer circumferential surface of the heater 201 and prevent the heat generated by the heater 201 from being externally discharged. In an embodiment, the insulation structure 401 may include a vacuum insulating layer arranged to surround the heater 201 to vacuum-insulate the heater 201, but one or more embodiments are not limited thereto.

The piezoelectric pressure sensor 500 may be arranged adjacent to the airflow passage 300 and connected thereto, thus detecting a pressure variation according to the puff action of the user. That is, the piezoelectric pressure sensor 500 may be fluid-connected to the airflow passage 300 and thus detect the pressure variation in the airflow passage 300.

The piezoelectric pressure sensor 500 may measure pressure or mechanical stress through a piezoelectric effect. In this case, pressure applied to the piezoelectric pressure sensor 500 may be converted into an electrical charge flow. Such a characteristic may be applied to measure the pressure or pressure variation.

The piezoelectric pressure sensor 500 according to an embodiment may be in the form of a disc. The piezoelectric pressure sensor 500 may include a piezoelectric element 501 and first and second electrodes 502 and 503. The piezoelectric element 501 includes a homogenous layer that includes a material sensitive to pressure. For example, the piezoelectric element 501 may include a piezoelectric material, such as PZT-ceramic or quartz. The piezoelectric pressure sensor 500 may include the piezoelectric element 501 that is a single body, and the first and second electrodes 502 and 503 may be respectively arranged on one surface and the other surface of the piezoelectric element 501. However, the shape of the piezoelectric pressure sensor 500 is not limited thereto, and the piezoelectric pressure sensor 500 may be variously designed in accordance with the structure of the aerosol generating device 10. For example, the piezoelectric pressure sensor 500 may be in the form of a film.

When puffs are sensed by the piezoelectric pressure sensor 500, the great linearity may be provided in a range of usage frequencies and amplitudes. Also, because of low sensitivity to an electromagnetic field, the piezoelectric pressure sensor 500 may have low interference with the heating-type heater 210 and sensors (not shown) for detecting changes in inductance and capacitance. To this end, by securing the measurement reliability, the piezoelectric pressure sensor 500 may accurately detect the pressure variation in the airflow passage 300 according to the puff action of the user.

The aerosol generating device 10 according to an embodiment may further include a processor 610 and a battery 620.

According to an embodiment, the processor 610 may be arranged or mounted on the printed circuit board 600 located in the inner space of the housing 100, but the arrangement of the processor 610 is not limited thereto.

The battery 620 may supply power used to operate the aerosol generating device 10.

For example, the battery 620 may supply power to the heater 201 to heat the same. Also, the battery 620 may supply the power required to operate the processor 610 or the piezoelectric pressure sensor 500.

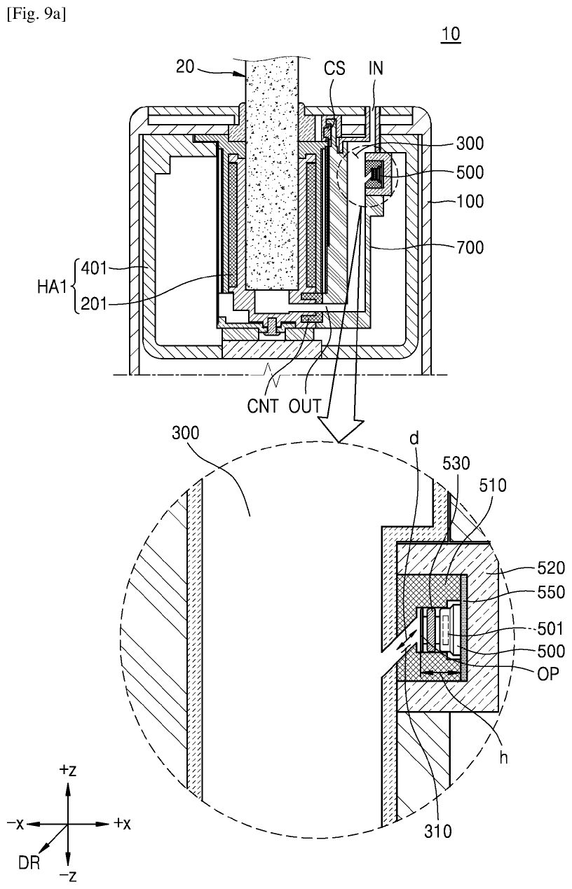

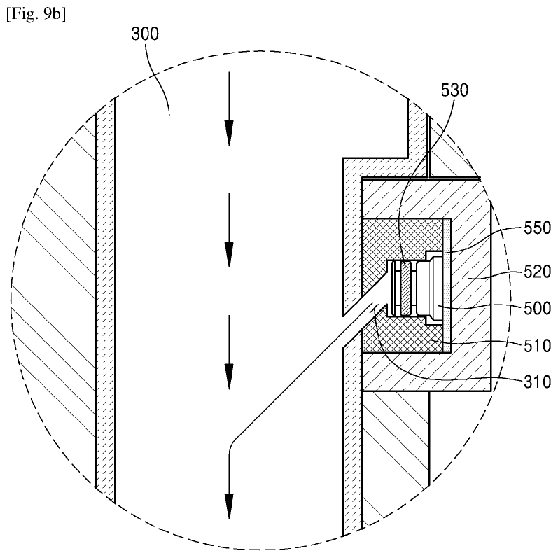

FIG. 9A is an enlarged cross-sectional view of some components of an aerosol generating device, according to another embodiment, and FIG. 9B is a diagram for explaining movement of air according to a puff action of a user in the aerosol generating device of FIG. 9A.

Referring to FIGS. 9A and 9B, the aerosol generating device 10 according to an embodiment may include a housing 100, a heating assembly HA1, a piezoelectric pressure sensor 500, an airflow assembly 700, and a processor (e.g., the processor 610 of FIG. 7). The aerosol generating device 10 of FIGS. 9A and 9B may be an embodiment of the aerosol generating device 10 of FIG. 2.

The heating assembly HA1 may include a heater 201 and an insulation structure 401.

The airflow assembly 700 may be spaced apart from the heating assembly HA1 and separately formed. The airflow assembly 700 may include the air inlet IN formed in an end of the airflow assembly 700 and an air outlet OUT formed in the other end of the airflow assembly 700 and connected to the air inlet IN by the airflow passage 300. The air outlet OUT may be connected to a connection passage CNT formed in a portion of the accommodation portion 110.

The airflow passage 300 may be arranged in the inner space of the airflow assembly 700 and connect or fluid-connect the heater 201 to the outside of the housing 100 or the aerosol generating device 10.

As described above, in the aerosol generating device 10 according to an embodiment, the airflow passage 300 is spaced apart from the heating assembly HA1 where the aerosol is generated, and is separately formed. Therefore, the pressure variation in the airflow passage 300, in which only the air flowing from the outside of the aerosol generating device 10 moves, may be detected. Accordingly, the measurement accuracy and reliability are secured by preventing the piezoelectric pressure sensor 500 from being contaminated with the droplets. As a result, the pressure variation in the airflow passage 300 according to the puff action of the user may be accurately detected.

If the airflow passage 300 is arranged adjacent to the heater 201, the heat generated by the heater 201 may change the temperature and/or pressure of the airflow passage 300 even though the puff action of the user is not performed. As such, the sensor 500 may incorrectly detect a puff action.

In the aerosol generating device 10 according to an embodiment, as the airflow passage 300 is spaced apart from the heating assembly HA1, where the aerosol is generated, and is separately formed. Therefore, the change in the temperature and/or the pressure of the airflow passage 300 may be prevented from changing by the heat generated by the heater 201. Accordingly, the accuracy of detecting the puff action of the user may be improved. Also, the malfunction or failure of the piezoelectric pressure sensor 500 by heat may be prevented.

The airflow assembly 700 according to an embodiment may further include a color sensor CS.

The color sensor CS may sense light reflected from the cigarette 20. The color sensor CS may obtain information regarding a color from the sensed light.

The color sensor CS may include an emission portion and a light-receiving portion. The emission portion may emit light towards the cigarette 20.

The light emitted from the emission portion may be reflected from the cigarette 20. The reflected light may reach the light-receiving portion. For example, the light-receiving portion 528b may include a photodiode reacting to light. The light-receiving portion 528b may output an electrical signal corresponding to light that is incident to the photodiode.

The processor (610 of FIG. 7) may receive a signal associated with color information from the color sensor CS. The processor may determine information based on the color information obtained by the color sensor CS. The processor may analyze a value that is output by the color sensor CS according to the obtained color information and may determine information regarding the cigarette 20. For example, the information regarding the cigarette 20 may include a type of the cigarette 20 and/or a humidity state of the cigarette 20.

The piezoelectric pressure sensor 500 may be arranged adjacent to the airflow passage 300 and connected to the airflow passage 300 through the vent hole 310, thus detecting the pressure variation in the airflow passage 300.

The vent hole 310 may be formed in the sensor bracket 510. A cross-sectional area of the vent hole 310 may be proportional to a surface size of the piezoelectric element 501. For example, the piezoelectric element 501 may be exposed through an opening OP of the piezoelectric pressure sensor 500. A cross-section of the opening OP may have a circular shape. A diameter of the opening OP may be 1.8 mm. In this case, the cross-section of the vent hole 310 may also have a circular shape, and the diameter of the vent hole 310 may also be 1.8 mm. As described, in the aerosol generating device 10 according to an embodiment, the cross-sectional area of the vent hole 310 is formed as great as possible in proportion to the surface size of the piezoelectric element 501 to secure the measurement accuracy, and thus, the pressure variation in the airflow passage 300 according to the puff action of the user may be accurately detected.

A minimum distance d from an end to the other end of the vent hole 310 according to an embodiment may be smaller than a height h of the piezoelectric pressure sensor 500. As described, in the aerosol generating device 10 according to an embodiment, the minimum distance d of the vent hole 310 is formed as small as possible to be close to the airflow passage 300 to secure the measurement accuracy, and thus, the pressure variation in the airflow passage 300 according to the puff action of the user may be accurately detected.

Also, the vent hole 310 according to an embodiment may extend diagonally with respect to the surface of the piezoelectric element 501 of the piezoelectric pressure sensor 500. For example, the lengthwise direction of the vent hole 310 may be a diagonal direction DR between a-x direction and a-z direction, which forms an acute angle with the upper surface of the piezoelectric element 501. As such, the liquid flowing from the outside or the droplets generated in the aerosol generation process may be prevented from being introduced into the vent hole 310.

The piezoelectric pressure sensor 500 may generate an electrical signal corresponding to the pressure variation in the airflow passage 300, and the electrical signal generated by the piezoelectric pressure sensor 500 may be transmitted to the processor (e.g., the processor 610 of FIG. 2) that is electrically or operatively connected to the piezoelectric pressure sensor 500.

According to an embodiment, the piezoelectric pressure sensor 500 may be arranged on a sensor printed circuit board 550 and may be electrically connected to the processor arranged on a printed circuit board through an electrical connection member (e.g., a flexible printed circuit board) connecting the sensor printed circuit board 550 to the printed circuit board (e.g., the printed circuit board 600 of FIG. 2), but one or more embodiments are not limited thereto.

As connected to the airflow passage 300 through the vent hole 310, the piezoelectric pressure sensor 500 may detect the pressure variation in the airflow passage 300. For example, the piezoelectric pressure sensor 500 may detect the pressure of the vent hole 310 that is connected to or fluid-connected to the airflow passage 300 and thus may sense or detect the pressure variation in the airflow passage 300.

The processor may be electrically or operatively connected to the piezoelectric pressure sensor 500 and detect the puff action of the user based on the pressure variation in the airflow passage 300 that is sensed or detected by the piezoelectric pressure sensor 500.

According to an embodiment, the processor may detect the puff action of the user based on a pressure decrement of the airflow passage 300 that is sensed or detected by the piezoelectric pressure sensor 500.

Because of the puff action of the user, a pressure difference may be generated between the outside of the housing 100 and the inside thereof, and thus, the air in the airflow passage 300 and/or the vent hole 310 may be discharged to the outside of the housing 100, resulting in the pressure drop in the airflow passage 300. Accordingly, the processor may detect the puff action of the user based on the pressure decrement of the airflow passage 300 that is sensed by the piezoelectric pressure sensor 500. The processor may, for example, compare a preset value and the pressure decrement of the airflow passage 300 that is sensed or detected by the piezoelectric pressure sensor 500, and when the pressure decrement of the airflow passage 300 is at least the preset value, the processor may determine that the user has performed the puff action. In this case, the preset value may vary according to the type of the aerosol generating device 10 or the user's setting. For example, the designated value P may be about 60 Pa to about 80 Pa, but is not limited thereto.

The aerosol generating device 10 according to an embodiment may further include the sensor bracket 510, the sensor cover 520, and/or the O-ring 530.

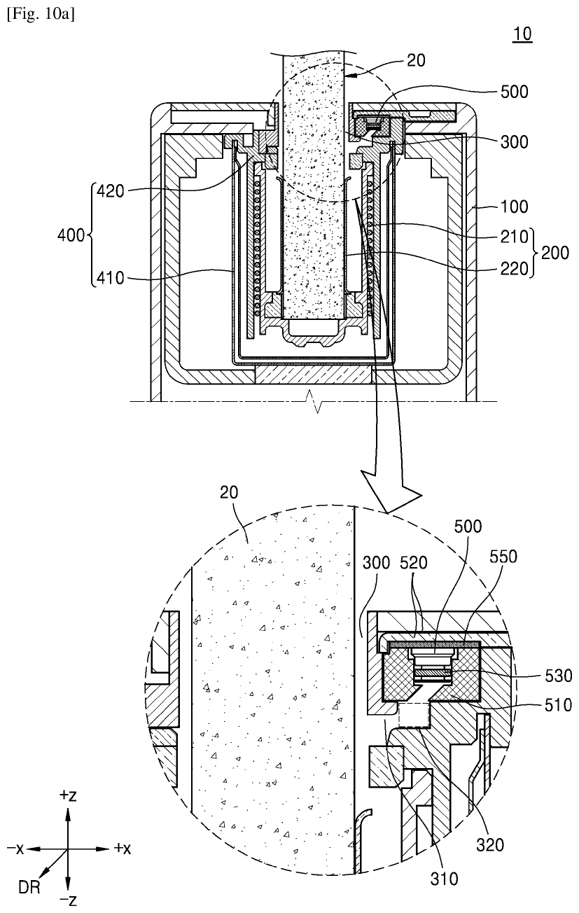

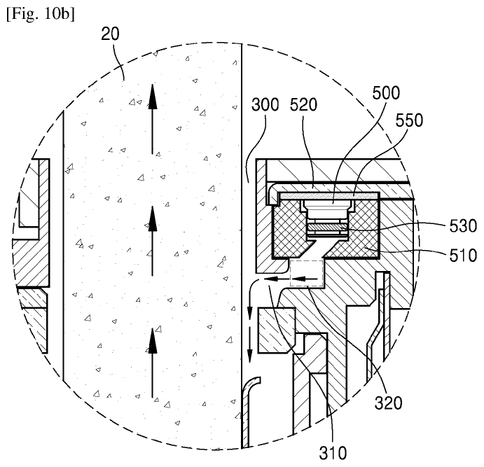

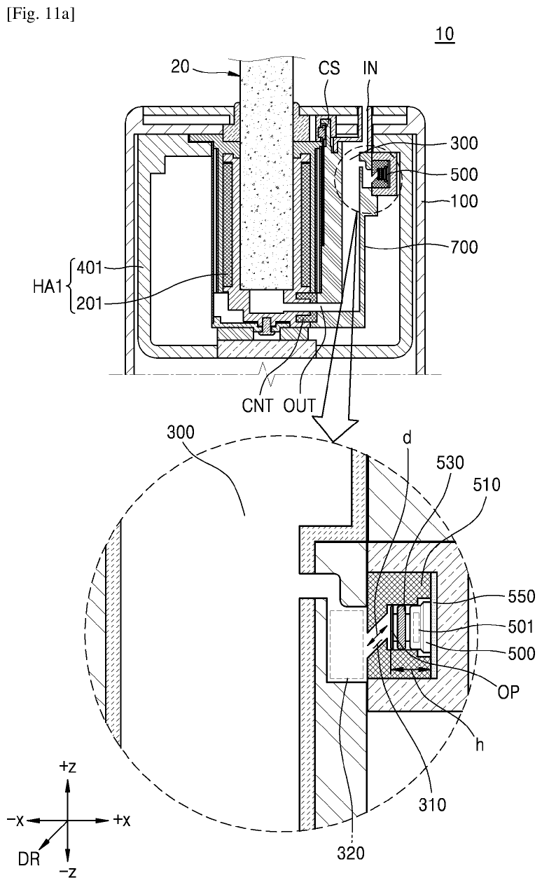

FIG. 10A is an enlarged diagram of some components of an aerosol generating device according to another embodiment. FIG. 10B is a diagram for explaining a process by which air moves in the aerosol generating device of FIG. 10A according to a puff action of a user.

When compared to the aerosol generating device 10 of FIG. 4A and/or FIG. 4B, the aerosol generating device 10 of FIGS. 10A and 10B additionally includes a chamber 320. Also, the arrangement of the piezoelectric pressure sensor 500 is changed.

Referring to FIGS. 10A and 10B, the aerosol generating device 10 may include the housing 100, the heater 200, the airflow passage 300, the vent hole 310, the chamber 320, the insulation structure 400, the piezoelectric pressure sensor 500, and the processor (e.g., the processor 610 of FIG. 2).

The airflow passage 300 may be arranged to connect the inside of the housing 100 to the outside of the housing 100 or the aerosol generating device 10 and function as a flow path through which air or an aerosol moves from the inside of the aerosol generating device 10 to the outside thereof or from the outside of the aerosol generating device 10 to the inside thereof.

For example, the aerosol generated inside the aerosol generating device 10 may pass through the cigarette 20 inserted into the housing 100 or move along the airflow passage 300, thus being discharged to the outside of the aerosol generating device 10 or the housing 100. As another example, air outside the aerosol generating device 10 (hereinafter, referred to as ‘external air’) may flow into the inner space of the housing 100 through the airflow passage 300.

The chamber 320 (or the ‘air chamber’) may be arranged apart from the airflow passage 300 at a preset distance and connected or fluid-connected to the piezoelectric pressure sensor 500 through the vent hole 310. The chamber 320 may be, for example, spaced apart from the airflow passage 300 in a direction crossing the lengthwise direction of the housing 100, and may be arranged in a space separated from the airflow passage 300.

Based on the connection structure, the air of the airflow passage 300 may flow into the chamber 320, or the air of the chamber 320 may be discharged through the airflow passage 300. The piezoelectric pressure sensor 500 may be spaced apart from the airflow passage 300 at a designated distance and located on a portion adjacent to the chamber 320, such that the pressure variation in the air in the chamber 320 may be detected. For example, the piezoelectric pressure sensor 500 may be connected or fluid-connected to the inner space of the chamber 320 through the vent hole 310 and may sense the pressure variation in the air in the chamber 320.

According to an embodiment, the piezoelectric pressure sensor 500 may generate an electrical signal corresponding to the pressure variation in the air in the inner space of the chamber 320, and the electrical signal generated by the piezoelectric pressure sensor 500 may be transmitted to the processor that is operatively connected to the piezoelectric pressure sensor 500.

Also, the piezoelectric pressure sensor 500 may be located on the upper portion of the chamber 320 separated from the airflow passage 300 and may reduce the amount of heat transmitted from the heater 200 and/or the insulation structure 400.

The aerosol generating device 10 according to an embodiment may further include a sensor bracket 510, a sensor cover 520, and an O-ring 530. However, according to an embodiment, at least one of the above-described components may be omitted.

The processor may be electrically or operatively connected to the piezoelectric pressure sensor 500 and detect the puff action of the user based on the pressure variation in the air in the chamber 320, the pressure variation being sensed by the piezoelectric pressure sensor 500.

According to an embodiment, the processor may detect the puff action of the user based on a pressure decrement of the chamber 320 that is sensed by the piezoelectric pressure sensor 500.

As illustrated in FIG. 10B, because of the puff action of the user, at least part of the air in the airflow passage 300 and/or the chamber 320 may pass through the cigarette 20 and be discharged to the outside of the housing 100.

For example, as the pressure outside the housing 100 decreases because of the puff action of the user, a pressure difference may be generated between the inside of the housing 100 and the outside thereof, and thus, at least part of the air in the airflow passage 300 and/or the chamber 320 may be discharged to the outside of the housing 100, resulting in the pressure drop in the airflow passage 300 and the chamber 320.

Accordingly, the processor may detect the puff action of the user based on the pressure decrement of the chamber 320 that is sensed by the piezoelectric pressure sensor 500. For example, the processor may compare a designated value with the pressure decrement of the chamber 320 that is sensed by the piezoelectric pressure sensor 500, and when the pressure decrement of the chamber 320 is at least the designated value, the processor may determine that the user has performed the puff action.

By detecting the pressure variation in the air in the chamber 320 instead of the airflow passage 300, the aerosol generating device 10 according to an embodiment may detect the puff action of the user more accurately, compared to when the pressure variation in the airflow passage 300 is detected.

As at least a portion of the heat generated by the heater 200 and/or the insulation structure 400 is transmitted to the inside of the chamber 320 through the airflow passage 300, the heat is added to the air in the chamber, and thus, kinetic energy of the air in the chamber 320 may increase. Unlike the air present in the airflow passage 300, the air in the chamber 320 exists in a certain space, and thus, an increase in the kinetic energy of the air may lead to a pressure increase in the chamber 320.

As a result, the pressure of the chamber 320 may remain relatively higher than that of the airflow passage 300 during the operation of the aerosol generating device 10. As the pressure of the chamber 320 is relatively higher than that of the airflow passage 300, the pressure decrement of the chamber according to the puff action of the user may be greater than the pressure decrement of the airflow passage 300. Depending on an operation environment or situation of the aerosol generating device 10, noise may be generated in the piezoelectric pressure sensor 500, and a pressure drop in the second chamber 320 may be detected by the piezoelectric pressure sensor 500 even when no puff action of the user is performed.

In this case, when the pressure decrement according to the puff action of the user is small, it is difficult to distinguish the pressure drop by the puff action of the user from the pressure drop by noise, and thus, the aerosol generating device 10 may recognize the pressure drop by noise as the pressure drop by the puff action of the user.

The aerosol generating device 10 according to an embodiment may detect the puff action of the user based on the pressure decrement of the chamber 320 where the pressure decrement by the puff action of the user is great, and thus may not misinterpret the pressure drop in the chamber 320 by noise as the pressure drop by the puff action of the user. That is, the aerosol generating device 10 according to an embodiment may reduce the chances of falsely detecting the puff action due to noise, thus accurately identifying the puff action of the user.

Also, the aerosol generating device 10 according to an embodiment may detect the puff action of the user based on the pressure decrement of the chamber 320 and thus may accurately detect the puff action of the user without scaling up (e.g., expanding an amplitude of a signal) a level of a signal of the piezoelectric pressure sensor 500 or amplifying a signal from the piezoelectric pressure sensor 500, wherein the level of the signal changes according to the pressure decrement of the chamber 320.

That is, because the aerosol generating device 10 may accurately detect the puff action of the user without performing a scaling-up operation or a signal amplifying operation, the time taken to detect the puff action of the user may be reduced. In addition, the aerosol generating device 10 may reduce the power consumption of the processor by simplifying a process by which the processor detects the puff action of the user, and as a result, the operation time of the aerosol generating device 10 may increase.

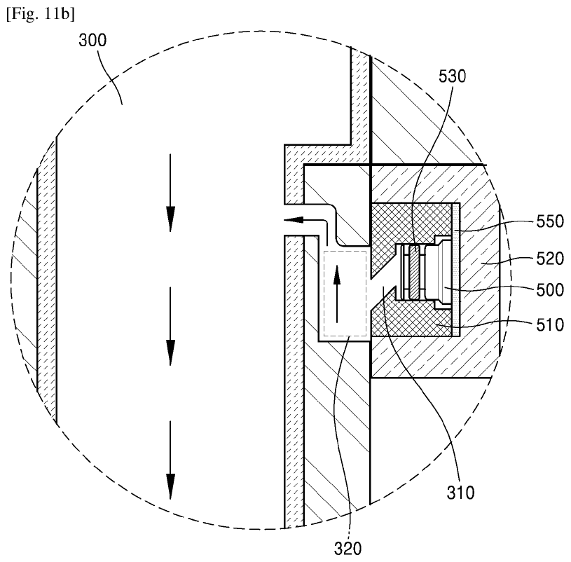

FIG. 11A is an enlarged cross-sectional view of some components of an aerosol generating device according to another embodiment. FIG. 11B is a diagram for explaining movement of air according to a puff action of a user in the aerosol generating device of FIG. 11A.

The aerosol generating device 10 of FIGS. 11A and 11B may be an aerosol generating device to which the chamber 320 is added, compared to the aerosol generating device 10 of FIG. 9A and/or FIG. 9B.

Referring to FIGS. 11A and 11B, an aerosol generating device 10 may include a housing 100, a heating assembly HA1, a piezoelectric pressure sensor 500, an airflow assembly 700, a chamber 320, and a processor (e.g., the processor 610 of FIG. 2).

The heating assembly HA1 may include a heater 201 and an insulation structure 401.

The airflow assembly 700 may be spaced apart from the heating assembly HA1 and separately formed. The airflow assembly 700 may include the air inlet IN formed in an end of the airflow assembly 700 and an air outlet OUT formed in the other end of the airflow assembly 700 and connected to the air inlet IN by the airflow passage 300. The air outlet OUT may be connected to a connection passage CNT formed in a portion of the accommodation portion 110.

The airflow passage 300 may be arranged in the inner space of the airflow assembly 700 and connect or fluid-connect the heater 201 to the outside of the housing 100 or the aerosol generating device 10.

The chamber 320 (or the ‘air chamber’) may be arranged apart from the airflow passage 300 by a preset distance and connected or fluid-connected to the piezoelectric pressure sensor 500 through the vent hole 310. The chamber 320 may be, for example, spaced apart from the airflow passage 300 in a direction crossing the lengthwise direction of the housing 100, and may be arranged in a space separated from the airflow passage 300.

Based on the connection structure, the air of the airflow passage 300 may flow into the chamber 320, or the air of the chamber 320 may be discharged through the airflow passage 300. The piezoelectric pressure sensor 500 may be spaced apart from the airflow passage 300 by a preset distance and located on a portion adjacent to the chamber 320 such that the pressure variation in the air in the chamber 320 may be detected. For example, the piezoelectric pressure sensor 500 may be connected or fluid-connected to the inner space of the chamber 320 through the vent hole 310 and may sense a pressure variation in air in the chamber 320.

According to an embodiment, the piezoelectric pressure sensor 500 may generate an electrical signal corresponding to the pressure variation in the air in the inner space of the chamber 320, and the electrical signal generated by the piezoelectric pressure sensor 500 may be transmitted to the processor that is operatively connected to the piezoelectric pressure sensor 500.

The aerosol generating device 10 according to an embodiment may further include a sensor bracket 510, a sensor cover 520, and an O-ring 530. However, according to an embodiment, at least one of the above-described components may be omitted.

The processor may be electrically or operatively connected to the piezoelectric pressure sensor 500 and detect the puff action of the user based on the pressure variation in the air in the chamber 320, the pressure variation being sensed by the piezoelectric pressure sensor 500.

According to an embodiment, the processor may detect the puff action of the user based on a pressure decrement of the chamber 320 that is sensed by the piezoelectric pressure sensor 500.

For example, as the pressure outside the housing 100 decreases because of the puff action of the user, a pressure difference may be generated between the inside of the housing 100 and the outside thereof, and thus, at least part of the air in the airflow passage 300 and/or the chamber 320 may be discharged to the outside of the housing 100, resulting in the pressure drop in the airflow passage 300 and the chamber 320.

Accordingly, the processor may detect the puff action of the user based on the pressure decrement of the chamber 320 that is sensed by the piezoelectric pressure sensor 500. For example, the processor may compare a designated value with the pressure decrement of the chamber 320 that is sensed by the piezoelectric pressure sensor 500, and when the pressure decrement of the chamber 320 is at least the designated value, the processor may determine that the user has performed the puff action.

By detecting the pressure variation in the air in the chamber 320 instead of the airflow passage 300, the aerosol generating device 10 according to an embodiment may detect the puff action of the user more accurately, compared to when the pressure variation in the airflow passage 300 is detected.

A cross-sectional area of an inlet of the chamber 320 may be smaller than that of the airflow passage 300. Accordingly, the chamber 320 may maintain a relatively higher pressure than the airflow passage 300 while the aerosol generating device 10 operates. As the pressure of the chamber 320 remains relatively higher than that of the airflow passage 300, the pressure decrement of the chamber 320 according to the puff action of the user may be greater than the pressure decrement of the airflow passage 300. Depending on an operation environment or situation of the aerosol generating device 10, noise may be generated in the piezoelectric pressure sensor 500, and a pressure drop in the second chamber 320 may be detected by the piezoelectric pressure sensor 500 even when no puff action of the user is performed.

In this case, when the pressure decrement according to the puff action of the user is small, it is difficult to distinguish the pressure drop by the puff action of the user from the pressure drop by noise, and thus, the aerosol generating device 10 may recognize the pressure drop by noise as the pressure drop by the puff action of the user.

The aerosol generating device 10 according to an embodiment may detect the puff action of the user based on the pressure decrement of the chamber 320 where the pressure decrement by the puff action of the user is great, and thus may not misinterpret the pressure drop in the chamber 320 by noise as the pressure drop by the puff action of the user. That is, the aerosol generating device 10 according to an embodiment may reduce the chances of falsely detecting the puff action due to noise, thus accurately identifying the puff action of the user.

Also, the aerosol generating device 10 according to an embodiment may detect the puff action of the user based on the pressure decrement of the chamber 320 and thus may accurately detect the puff action of the user without scaling up (e.g., expanding an amplitude of a signal) a level of a signal of the piezoelectric pressure sensor 500 or amplifying a signal from the piezoelectric pressure sensor 500, wherein the level of the signal changes according to the pressure decrement of the chamber 320.

That is, because the aerosol generating device 10 may accurately detect the puff action of the user without performing a scaling-up operation or a signal amplifying operation, the time taken to detect the puff action of the user may be reduced. In addition, the aerosol generating device 10 may reduce the power consumption of the processor by simplifying a process by which the processor detects the puff action of the user, and as a result, the operation time of the aerosol generating device 10 may increase.

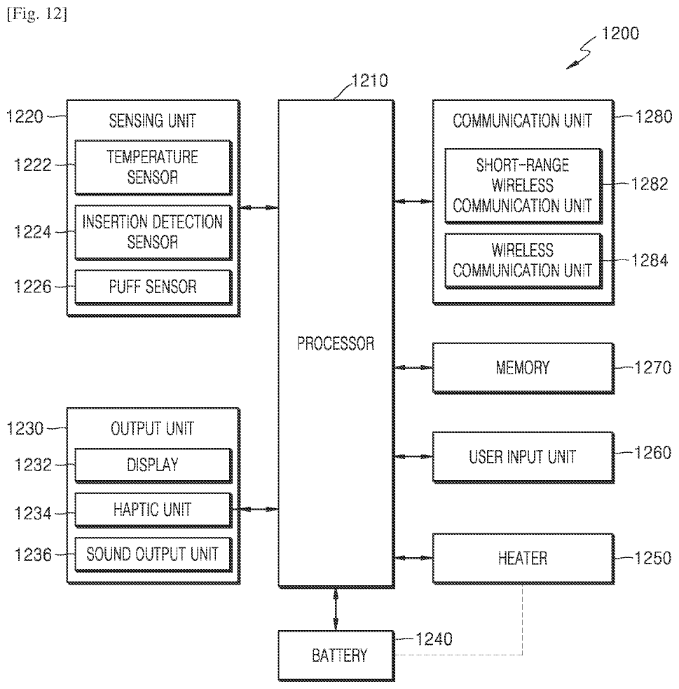

FIG. 12 is a block diagram of an aerosol generating device 1200 according to another embodiment.

The aerosol generating device 1200 may include a controller 1210, a sensing unit 1220, an output unit 1230, a battery 1240, a heater 1250, a user input unit 1260, a memory 1270, and a communication unit 1280. However, the internal structure of the aerosol generating device 1200 is not limited to those illustrated in FIG. 12. That is, according to the design of the aerosol generating device 1200, it will be understood by one of ordinary skill in the art that some of the components shown in FIG. 12 may be omitted or new components may be added.

The sensing unit 1220 may sense a state of the aerosol generating device 1200 and a state around the aerosol generating device 1200, and transmit sensed information to the controller 1210. Based on the sensed information, the controller 1210 may control the aerosol generating device 1200 to perform various functions, such as controlling an operation of the heater 1250, limiting smoking, determining whether an aerosol generating article (e.g., a cigarette, a cartridge, or the like) is inserted, displaying a notification, or the like.

The sensing unit 1220 may include at least one of a temperature sensor 1222, an insertion detection sensor, and a puff sensor 1226, but is not limited thereto.

The temperature sensor 1222 may sense a temperature at which the heater 1250 (or an aerosol generating material) is heated. The aerosol generating device 1200 may include a separate temperature sensor for sensing the temperature of the heater 1250, or the heater 1250 may serve as a temperature sensor. Alternatively, the temperature sensor 1222 may also be arranged around the battery 1240 to monitor the temperature of the battery 1240. In an embodiment, the temperature sensor 1222 may measure the temperature of the heater 1250 before it is heated.

The insertion detection sensor 1224 may sense insertion and/or removal of an aerosol generating article. For example, the insertion detection sensor 1224 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article. If the insertion detection sensor 1224 detects insertion of the aerosol generating article and then detects insertion of the aerosol generating article again within a predetermined time after the one-time smoking series ends, it may be determined to be continuous use.

The puff sensor 1226 may sense a user's puff on the basis of various physical changes in an airflow passage or an airflow channel. For example, the puff sensor 1226 may sense a user's puff on the basis of any one of a temperature change, a flow change, a voltage change, and a pressure change.

The sensing unit 1220 may include, in addition to the temperature sensor 1222, the insertion detection sensor 1224, and the puff sensor 1226 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1230 may output information on a state of the aerosol generating device 1200 and provide the information to a user. The output unit 1230 may include at least one of a display unit 1232, a haptic unit 1234, and a sound output unit 1236, but is not limited thereto. When the display unit 1232 and a touch pad form a layered structure to form a touch screen, the display unit 1232 may also be used as an input device in addition to an output device.

The display unit 1232 may visually provide information about the aerosol generating device 1200 to the user. For example, information about the aerosol generating device 1200 may mean various pieces of information, such as a charging/discharging state of the battery 1240 of the aerosol generating device 1200, a preheating state of the heater 1250, an insertion/removal state of an aerosol generating article, or a state in which the use of the aerosol generating device 1200 is restricted (e.g., sensing of an abnormal object), or the like, and the display unit 1232 may output the information to the outside. The display unit 1232 may be, for example, a liquid crystal display panel (LCD), an organic light-emitting diode (OLED) display panel, or the like. In addition, the display unit 1232 may be in the form of a light-emitting diode (LED) light-emitting device.

The haptic unit 1234 may tactilely provide information about the aerosol generating device 1200 to the user by converting an electrical signal into a mechanical stimulus or an electrical stimulus. For example, the haptic unit 1234 may include a motor, a piezoelectric element, or an electrical stimulation device.

The sound output unit 1236 may audibly provide information about the aerosol generating device 1200 to the user. For example, the sound output unit 1236 may convert an electrical signal into a sound signal and output the same to the outside.

The battery 1240 may supply power used to operate the aerosol generating device 1200. The battery 1240 may supply power such that the heater 1250 may be heated. In addition, the battery 1240 may supply power required for operations of other components (e.g., the sensing unit 1220, the output unit 1230, the user input unit 1260, the memory 1270, and the communication unit 1280) in the aerosol generating device 1200. The battery 1240 may be a rechargeable battery or a disposable battery. For example, the battery 1240 may be a lithium polymer (LiPoly) battery, but is not limited thereto.

The heater 1250 may receive power from the battery 1240 to heat an aerosol generating material. Although not illustrated in FIG. 12, the aerosol generating device 1200 may further include a power conversion circuit (e.g., a direct current (DC)/DC converter) that converts power of the battery 1240 and supplies the same to the heater 1250. In addition, when the aerosol generating device 1200 generates aerosols in an induction heating method, the aerosol generating device 1200 may further include a DC/alternating current (AC) that converts DC power of the battery 1240 into AC power.

The controller 1210, the sensing unit 1220, the output unit 1230, the user input unit 1260, the memory 1270, and the communication unit 1280 may each receive power from the battery 1240 to perform a function. Although not illustrated in FIG. 12, the aerosol generating device 1200 may further include a power conversion circuit that converts power of the battery 1240 to supply the power to respective components, for example, a low dropout (LDO) circuit, or a voltage regulator circuit.

In an embodiment, the heater 1250 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1250 may be implemented by a metal wire, a metal plate on which an electrically conductive track is arranged, a ceramic heating element, or the like, but is not limited thereto.

In another embodiment, the heater 1250 may be a heater of an induction heating type. For example, the heater 1250 may include a susceptor that heats an aerosol generating material by generating heat through a magnetic field applied by a coil.

In one embodiment, the heater 1250 may include a plurality of heaters. For example, the heater 1250 may include a first heater for heating a cigarette and a second heater for heating a liquid.

The user input unit 1260 may receive information input from the user or may output information to the user. For example, the user input unit 1260 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 12, the aerosol generating device 1200 may further include a connection interface, such as a universal serial bus (USB) interface, and may connect to other external devices through the connection interface, such as the USB interface, to transmit and receive information, or to charge the battery 1240.

The memory 1270 is a hardware component that stores various types of data processed in the aerosol generating device 1200, and may store data processed and data to be processed by the controller 1210. The memory 1270 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1270 may store an operation time of the aerosol generating device 1200, the maximum number of puffs, the current number of puffs, at least one temperature profile, data on a user's smoking pattern, etc. In embodiments, the memory 1270 may store multiple temperature profiles. Additionally, the memory 1270 may store a plurality of preheating profiles that define preheating sections among the temperature profiles. The memory 1270 may store a plurality of preheating profiles described with reference to FIGS. 8 and 9.

The communication unit 1280 may include at least one component for communication with another electronic device. For example, the communication unit 1280 may include a short-range wireless communication unit 1282 and a wireless communication unit 1284.

The short-range wireless communication unit 1282 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 1284 may include a cellular network communication unit, an Internet communication unit, a computer network (e.g., local area network (LAN) or wide area network (WAN)) communication unit, or the like, but is not limited thereto. The wireless communication unit 1284 may also identify and authenticate the aerosol generating device 1200 within a communication network by using subscriber information (e.g., International Mobile Subscriber Identifier (IMSI)).

The controller 1210 may control general operations of the aerosol generating device 1200. In an embodiment, the controller 1210 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

Those of ordinary skill in the art related to the present embodiments may understand that various changes in form and details can be made therein without departing from the scope of the characteristics described above. Therefore, the disclosed methods should be considered in a descriptive point of view, not a restrictive point of view. The scope of the present disclosure is defined by the appended claims rather than by the foregoing description, and all differences within the scope of equivalents thereof should be construed as being included in the present disclosure.

1. An aerosol generating device comprising:
a housing comprising:
an accommodation portion configured to accommodate a cigarette; and
an airflow passage fluid-connected to the accommodation portion;
a piezoelectric pressure sensor arranged adjacent to a portion of the airflow passage and fluid-connected to the airflow passage through a vent hole; and
a processor configured to calculate a pressure variation in the airflow passage by using the piezoelectric pressure sensor,
wherein the vent hole extends diagonally with respect to a surface of a piezoelectric element of the piezoelectric pressure sensor.

2. The aerosol generating device of claim 1, wherein a cross-sectional area of the vent hole corresponds to an area of the surface of the piezoelectric element.

3. The aerosol generating device of claim 1, wherein a minimum distance from an end to another end of the vent hole is less than a height of the piezoelectric pressure sensor.

4. The aerosol generating device of claim 1, further comprising:
a sensor bracket comprising the vent hole and configured to support the piezoelectric pressure sensor;
a sensor cover arranged to cover at least a portion of an outer side surface of the piezoelectric pressure sensor and configured to dissipate heat of the piezoelectric pressure sensor; and
an O-ring arranged between the sensor bracket and the piezoelectric pressure sensor and configured to prevent the piezoelectric pressure sensor from moving.

5. The aerosol generating device of claim 1, wherein the processor is further configured to, when the pressure variation is greater than or equal to a preset value, determine that a puff action has occurred, calculate a cumulative number of detected puff actions, calculate a number of remaining puffs for the cigarette by subtracting the cumulative number of the detected puff actions from a preset number of available puffs for the cigarette.

6. The aerosol generating device of claim 5, further comprising a display configured to display the number of remaining puffs for the cigarette.

7. The aerosol generating device of claim 1, further comprising a heating assembly configured to generate an aerosol by heating the cigarette.

8. The aerosol generating device of claim 7, wherein the heating assembly comprises:
the accommodation portion;
a solenoid coil cylindrically wound in a lengthwise direction of the accommodation portion and configured to generate an alternating magnetic field; and
a first susceptor configured to generate heat in response to the alternating magnetic field generated by the solenoid coil to heat the cigarette.

9. The aerosol generating device of claim 7, wherein the heating assembly comprises:
the accommodation portion; and
a spiral coil arranged on an outer side of the accommodation portion and configured to generate an induction magnetic field towards the accommodation portion,
wherein the spiral coil is wound to form a planar shape covering a portion of an outer wall of the accommodation portion, and a center around which the spiral coil is wound is located at a point of the outer wall of the accommodation portion.

10. The aerosol generating device of claim 9, wherein the spiral coil is arranged in plural, and a plurality of spiral coils are electrically connected to each other.

11. The aerosol generating device of claim 9, wherein the airflow passage is formed in an airflow assembly disposed apart from the heating assembly.

12. The aerosol generating device of claim 11, wherein the airflow assembly comprises:
an air inlet formed in an end of the airflow assembly; and
an air outlet formed in another end of the airflow assembly and connected to the air inlet by the airflow passage, and
wherein the air outlet is coupled to a connection passage formed in the accommodation portion.

13. An aerosol generating device comprising:
a housing comprising:
an accommodation portion configured to accommodate a cigarette;
an airflow passage fluid-connected to the accommodation portion; and
a chamber arranged apart from the airflow passage;
a piezoelectric pressure sensor arranged adjacent to the chamber and fluid-connected to the chamber through a vent hole; and
a processor configured to calculate a pressure variation in the chamber by using the piezoelectric pressure sensor,
wherein the vent hole extends diagonally with respect to a surface of a piezoelectric element of the piezoelectric pressure sensor.

14. The aerosol generating device of claim 13, wherein a cross-sectional area of the vent hole corresponds to an area of the surface of the piezoelectric element.

15. The aerosol generating device of claim 13, wherein a minimum distance from an end to another end of the vent hole is less than a height of the piezoelectric pressure sensor.
